(19) United States
(12) Patent Application Publication
(10) Pub. No.: US 2007/0210473 A1
(43) Pub. Date: Sep. 13, 2007

(54) USING OIL-BASED ADDITIVES TO IMPROVE LIGNOCELLULOSIC FIBRE BONDING AND DIMENSIONAL PERFORMANCE

(76) Inventors: Sunguo Wang, Edmonton (CA); Wayne Wasylciw, Edmonton (CA); Guoliang QU, Edmonton (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 11/308,222

(22) Filed: Mar. 13, 2006

(51) Int. Cl. B27N 3/00

(52) U.S. Cl. 264/109

(57) ABSTRACT

About 78.0-91.4% refined lignocellulosic fibres were blended with 8.0-12.0% formaldehyde-based resin, 0.5-2.0% wax and 0.1-8.0% oil in a blowline or a blender before mat forming and panel pressing. Fibres can be from cereal straws or wood species. Wax can be slack or emulsified wax. Oil is selected from different groups including, but not being limited to, vegetable oils, tree oils and any kinds of oils and oil mixtures which consist of fatty acids with 12 to 24 carbon atoms. Inverse Gas Chromatography (IGC) measurement and MDF panel test results have shown that fibre adhesion characteristics have changed significantly, leading to significant panel internal bond (IB) and dimensional stability improvements.

### FIELD OF THE INVENTION

The present invention relates to methods of adding oil-based additives into lignocellulosic fibres and forming medium density fibreboard (MDF).

### BACKGROUND OF THE INVENTION

The incompatibility of formaldehyde-based resins including urea formaldehyde resin (UF) and melamine urea formaldehyde (MUF), with cereal straws is reflected in current commercial ventures making panels from these materials. Conventional strawboard plants use methyl diphenyl isocyanate (MDI) as the binder in an effort to make particleboard. While MDI is an excellent binder and imparts superior properties to panels, MDI has some inherent disadvantages, including its high cost and low tack, which are critical issues in the preparation of straw based non-structural panels.

Another significant disadvantage is the tendency of MDI to adhere to press platens during panel pressing. A variety of releasing techniques are available to overcome the bonding of MDI to press platens, such as release agents and release papers. However, when compared to UF-based resins, the use of internal and external release agents and release papers is expensive and thus adds to the cost of the end product. Lower binder costs, lower process costs, increased ease of implementation and better mat integrity all provide incentive to use formaldehyde-based binders for lignocellulosic nonstructural panels. The barrier has been the inability of formaldehyde-based resins to bond with fibres such as straw fibres to exceed minimum commercial standards.

Therefore there is a need in the art for improved methods of processing lignocellulosic fibres to form panels using formaldehyde-based resins, because of the above-mentioned advantages of formaldehyde-based resins.

### SUMMARY OF THE INVENTION

It is believed that acid treatment of hammer milled and atmospherically refined wheat straw results in improved UF and MUF bonding to wheat straw, where the role of the acid is most likely a chemical modifier rather than a wax/silica stripper. Furthermore, it is believed that high pressure steam refining of straw fibre also improves bonding with UF or MUF binders.

The present invention comprises the addition of oils to lignocellulosic fibre, resulting in panels with improved panel properties. In this invention, refined lignocellulosic fibres are blended with a formaldehyde-based resin, a wax and an oil. The mixture may be mixed in a blowline or a blender before mat forming and panel pressing. The fibres may be cereal straw fibres or from suitable wood species. The wax may be any suitable wax such as slack or emulsified wax. The oil is selected from different groups including, but not limited to, vegetable oils, tree oils and any kinds of oils and oil mixtures which may comprise short chain or long chain fatty acids.

In one embodiment, the panel is formed from a mixture of about 78.0-91.4% refined lignocellulosic fibres, 8.0-12.0% formaldehyde-based resin, 0.5-2.0% wax and 0.1-8.0% oil, all of which are blended in a blowline or a blender before mat forming and panel pressing.

### DETAILED DESCRIPTION OF THE INVENTION

The present invention provides for a method of pressing lignocellulosic fibres to produce fibre based panels such as MDF. When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as claimed herein.

Lignocellulosic fibres are fibres comprising lignin and cellulose found in woody plant cells, including hardwood and softwood species, and agrifibres which may include cereal grain straws, other fibrous plant materials such as hemp and kenaf, residues from agricultural processing such as bagasse and palm fibre and straws from oilseeds such as canola, flax and rapeseed. Cereal grain straw comprises straw collected from cereal grain crops and includes but is not limited to wheat, oats, barley, rice and rye.

The production of fibres from lignocellulosic sources is well known in the industry and need not be detailed here. Cereal straw fibres may be produced using any known or published methods. The methods described in co-owned U.S. Pat. No. 6,929,854 entitled “Methods of Straw Fibre Processing” (the contents of which are incorporated herein by reference) may be suitable. The art of producing wood fibres is advanced, and one skilled in the art may have reference to numerous effective techniques which are well-known in the art.

If straw fibres are used, the straw is preferably hammer milled to reduce the straw to suitable lengths, preferably less than about 50 mm and greater than 12 mm. Other means for cutting the straw into suitable lengths may be used, such as straw slicers or forage choppers. The cut or hammer-milled straw may then screened to remove extremely fine fibres or larger fibres. The milled and screened fibres may then be washed with water to rinse out dirt and small foreign objects and to wet the straw, which may raise the moisture content of the straw. Alternatively, the straw may be rinsed or wetted prior to cutting or hammer milling. Preferably, the straw has a moisture content of about 30% prior to steam treatment.

The straw is then fed, by way of a plug screw feeder or similar device, into a steam digester where it is preferably subjected to an initial steam pre-treatment. The steam pressure is preferably greater than about 6.0 bar, more preferably greater than about 8.0 bars and most preferably greater than about 10.0 bar. We have found that useful straw fibre results even at pressures of 12.0 bar or higher.

It is preferred that the straw be contacted with high pressure steam during a digesting or straw softening step or during refining, or preferably during both digesting and refining. From the steam digester, the straw may then be directed to a steam pressurized mechanical refiner. Suitable refiners are well known in the art. Steam pressure refining results in a more fibrillated material than atmospheric refining. In either instance, the refining takes place with low specific energy consumption as compared to refining of wood fibre in an equivalent process.

The straw may be subject to high-pressure steam in the digester and in the refiner. In a laboratory scale digester-refiner, the cumulative duration of the steam treatment is preferably greater than about 3 minutes and more preferably greater than about 5 minutes. It will be obvious to those skilled in the art that dwell time in a steam pressurized digester and refiner may be shortened in larger, commercial scale apparatuses. More severe steam treatment (higher pressure, greater duration) results in a more fibrillated, darker material. The steam treatment may take place in any pressurized vessel and may include a continuous digester that includes a screw-type augur to move the straw through the digester and into the refiner.

One skilled in the art may, with minimum experimentation, use various combinations of steam pressure, refiner retention time and refiner size to achieve desirable results. At higher steam pressure, shorter digester/refiner retention times are possible. At 6.0 bars of steam pressure, it is likely that digester/refiner retention times in excess of 8 minutes may be preferred. At 12.0 bars, refiner retention times may be less than about 3 minutes. As well, as is well known in the art, larger refiners may be used to shorten retention times, with equivalent results.

Suitable refined fibres may be dried while or before mixing with resin, a wax, and an oil. Preferably, the resin is formaldehyde-based resin such as urea-formaldehyde resin (UF resin) or a melamine urea formaldehyde resin (MUF resin).

Waxes are imprecisely defined, but generally understood to be a hydrocarbon substance with certain properties, namely:
plastic (malleable) at normal ambient temperatures;
a melting point above approximately 45° C. (which differentiates waxes from fats and oils);
a relatively low viscosity when melted (unlike many plastics); and
insoluble in water.

Suitable waxes include slack wax or emulsified wax. Slack wax is a mixture of petroleum oil and wax, obtained from dewaxing lubricating oil. It is the crude wax produced by chilling and solvent filter-pressing wax distillate. It is a known additive to MDF and OSB panels and acts as a water repellent. Emulsified wax is a wax mixed with detergents so it can be suspended in water. It simplifies the spraying process in some systems. Emulsified wax is not commonly used, but can be used in MDF manufacture. In one embodiment, the wax amount in MDF may be present in quantities less than about 2.0% by weight of oven dry fibre, preferably above about 0.5%.

The oil may be chosen from different groups including, but not being limited to, vegetable oils, tree oils and any kinds of oils and oil mixtures which may comprise saturated or unsaturated short chain or long chain fatty acids (fatty acids having 12 to 24 carbon atoms). Suitable oils include tree oils such as tung oil, pine oil, and cedar oil, vegetable oils such as sunflower oil, canola oil, corn oil, and linseed oil, and may include blends of suitable oils.

In one embodiment, the panel is formed from a mixture formed by mixing about 78.0-91.4% lignocellulosic fibres with about 8.0-12.0% formaldehyde-based resin, about 0.5-2.0% slack wax or emulsified wax, and about 0.1-8.0% oil (by weight). Preferably, the mixture is about 1% wax, and more preferably about 0.5-2% oil.

### EXAMPLES

The following examples are representative of the claimed invention and are not intended to be limiting thereof.

### Example 1

Straw was milled, atmospherically refined or steam pressure refined, as shown in Table 1. Specfic energy consumption during refining was about 250 kWh per ton of oven dry straw.

TABLE 1
Straw fibre preparation methods

| Type | Process |
|---|---|
| M (milled straw) | Hammer milled to 20 mm length then refined dry |
| | in PSKM mill. >10 mesh and <80 mesh fibres |
| | removed. |
| AR (atmospherically | Hammer milled straw wet to 30% moisture content |
| refined straw) | then refined in a Sprout Bauer 300 mm (12 in.) |
| | atmospheric refiner. |
| PR (pressure | Hammer milled straw wet to 30% moisture content |
| refined straw) | then refined in 900 mm (36 in.) Andritz |
| | Pressurised Refiner. Pre-steamed at 483 kPa (70 |
| | psi) for two (2) minutes. |

### Example 2

Table 2 lists different formulations mixing certain percentages of fibre, resin, wax, and oil in a blowline or blender.

TABLE 2
Straw or wood fibres mixing with different oils

| Oil Types | Formulations and processes |
|---|---|
| Vegetable oils | 78.0-91.4% fibres were mixed with 8.0-12.0% resin, |
| | 0.5-2.0% wax and 0.1-8.0% vegetable oil before mat |
| | forming and panel pressing. |
| Tree oils | 83.0-91.4% fibres were mixed with 8.0-12.0% resin, |
| | 0.5-2.0% wax and 0.1-3.0% tree oil before mat forming |
| | and panel pressing. |
| Other type of | 81.0-91.4% fibres were mixed with 8.0-12.0% resin, |
| oils | 0.5-2.0% wax and 0.1-5.0% other type of oil before mat |
| | forming and panel pressing. |

### Example 3

Before making MDF panels, the formulated fibres were analyzed using Inverse Gas Chromatography (IGC) to identify their dispersive and acid-base characteristics before and after adding oils. These characteristics are closely related to the fibre adhesion behaviors according to the acid-base theory.

IGC measurement and MDF panel test results have shown that fibre dispersive and acid-base characteristics have changed significantly, leading to panel internal bond (IB) and dimensional stability improvements (i.e. smaller thickness swell (TS) and less water absorption (WA)). Depending on oil and fibre types, internal bond (IB) increased by 9-45% and thickness swell (TS) dropped by 30-72%, while bending properties kept constant or somewhat improved.

IGC measurements at infinite dilution were carried out at 50° C. Helium was the inert carrier gas. The probes, along with their molecular properties used in the IGC experiment, are shown in Table 3.

According to the acid-base theory, both physical (Lifshitz-van der Waals or dispersive) interactions and the acid-base interactions will contribute to the work of adhesion. Adding oils enhanced either or both of the two chemical interactions in the fibre-resin-wax system and thus improved final internal bond (IB) and dimensional stability of MDF thereafter.

TABLE 3
Properties of the probes used in the IGC experiment

| | | | DN | AN |
|---|---|---|---|---|
| | a | γ_{L}^{d} | (kcal/mol, | (arbitrary unit, |
| Probes | (Å²) | (mJ/m²) | basic) | acidic) |
| n-Hexane | 51.5 | 19.4 | 0.0 | 0.0 |
| n-Octane | 57.0 | 21.3 | 0.0 | 0.0 |
| n-Decane | 75.0 | 23.4 | 0.0 | 0.0 |
| Acetone | 42.5 | 16.5 | 17.0 | 12.5 |
| THF | 45.0 | 22.5 | 20.1 | 8.0 |
| CHCl₃ | 44.0 | 25.9 | 0.0 | 25.1 |

Where:
A-molecular diameter;
γ_{L}^{d}-dispersive energy of probes;
DN-electron pair donor number;
AN-electron pair acceptor number.

From the retention time measured by IGC, the net retention volume (the volume of carrier gas required to elute a zone of solute vapour), per gram of adsorbent, can be determined by equation one:

$${V}_{g} = \frac{273.15 Q}{{T}_{c} \times W} ( {t}_{r} - {t}_{i} ) \qquad ( 1 )$$

Where:

T_{c} is column temperature.

W is the amount in grams of adsorbent packed into the column.

Q is the corrected flow rate of the propane gas.

tᵣ and tᵢ are the retention times of probes and inert gas, respectively.

The Gray method was used to determine the dispersive energy. The increment of the free energy of a methylene group
ΔG_{CH}_{₂}⁰
in the n-alkane series with the general formula CₙH₂ₙ₊₂ was considered.
ΔG_{CH}_{₂}⁰=ΔG_{C}_{ₙ₊₁}_{H}_{₂ₙ₊₄}⁰−ΔG_{C}_{ₙ}_{H}_{₂ₙ₊₂} (2)

The dispersive energy can be computed by:

$${γ}_{s}^{d} = {\frac{1}{{γ}_{{CH}_{2}}} [ \frac{Δ {G}_{{CH}_{2}}}{2 Na} ]}^{2} \\ Δ {G}_{{CH}_{2}}^{0} \qquad ( 3 )$$

is obtained from the slope of InV_{g} versus number of carbon atoms of a series of n-alkanes, which is:

$$Δ {G}_{{CH}_{2}} = RT ln \frac{{V}_{g ( {C}_{n + 1} {H}_{2 n + 4} )}}{{V}_{g ( {C}_{n} {H}_{2 n + 2} )}} \qquad ( 4 )$$

Where:

N is Avogadro's number which equals 6.02×10²³.

a is the surface area of a CH₂ group (6 Å²).
γ_{CH}_{₂}
is the surface energy of a CH₂ group (35.6 mJ/m²).

According to Guttmann's approach, the acid-base probes are characterized by their donor-acceptor numbers (Table 3). The donor number (DN) defines the basic characteristics or electron donor ability, which is estimated by the molar enthalpy of the reaction of the donor with the acidic reference SbCl₅. The acceptor number (AN) provides the acidity or electron acceptor ability, which corresponds to NMR chemical shift of ³¹P after reaction of triethylphosphine (C₂H₅)₃PO with the acceptor and has an arbitrary unit. An acid attracts electrons while a base releases electrons. Here DN and AN have different units, which will not affect relative comparisons between fibre formulations in this experiment.

The results give the dispersion force in the range of 5.00 and 35.00 mJ/m², and the acid-base characteristics in the range of 0.55 and 3.50 according to the Inverse Gas Chromatography (IGC) results.

In general, higher dispersion energy and acid-based characteristics lead to better fibre adhesion (internal bond), as demonstrated in Tables 4-8. Depending on oil and fibre types, IB has increased by 9-45% and TS has dropped by 30-72% while bending properties kept constant or a little bit improved.

Tables 4 and 5 show the dispersive energy and the acid-base characteristics of different straw fibre formulations.

TABLE 4
Effect of straw samples on dispersion energy

| Fibre formulations | γₛ^{d} (mJ/m²) |
|---|---|
| UF + straw + wax + Tung oil | 7.59 |
| UF + straw + wax + sunflower oil | 12.03 |
| UF + straw + wax + pine oil | 13.78 |
| UF + straw + wax + canola oil | 21.37 |
| UF + straw + wax + corn oil | 21.71 |
| UF + straw + wax | 23.71 |
| UF + straw + wax + linseed oil | 29.09 |

TABLE 5
Effect of straw samples on acid-base characteristics

| | Acidic | Basic | Acid-base |
|---|---|---|---|
| | character- | character- | characteristic |
| Fibre formulations | istic | istic | [2*(acidic*basic)^{1/2}] |
| UF + straw + wax | 0.56 | 0.00 | 0.00 |
| UF + straw + wax + | 0.82 | 0.18 | 0.77 |
| sunflower oil | | | |
| UF + straw + wax + | 0.71 | 0.65 | 1.36 |
| corn oil | | | |
| UF + straw + wax + | 0.96 | 0.37 | 1.19 |
| tung oil | | | |
| UF + straw + wax + | 1.07 | 0.50 | 1.46 |
| canola oil | | | |
| UF + straw + wax + | 0.69 | 0.81 | 1.50 |
| linseed oil | | | |

### Example 4

Table 6 below shows the effect of oil type on wheat straw MDF panel performance. The nominal panel density was 736 kg/m3 and the nominal panel thickness was 12.5 mm. 10% UF resin and 1% slack wax were added unless noted otherwise. Oil content is based on oven dry fibre weight.

TABLE 6
Impact of oil type on panel properties

| | MOE, | MOR, | IB, | TS, | WA, |
|---|---|---|---|---|---|
| Formulations | MPa | MPa | MPa | mm | % |
| Straw + resin + wax | 2747 | 22.4 | 0.946 | 3.2 | 90.2 |
| Straw + resin + wax + | 2819 | 23.3 | 0.962 | 1.0 | 18.9 |
| canola oil | | | | | |
| Straw + resin + wax + | 3124 | 25.8 | 1.031 | 1.8 | 39.0 |
| pine oil | | | | | |
| Straw + resin + wax + | 3056 | 25.4 | 1.086 | 0.9 | 18.3 |
| linseed oil | | | | | |
| Straw + resin + wax + | 3230 | 27.3 | 1.135 | 0.9 | 18.8 |
| corn oil | | | | | |
| Straw + resin + wax + | 3278 | 26.6 | 1.228 | 1.3 | 30.0 |
| cedar oil | | | | | |

### Example 5

Table 7 indicates the impact of cedar oil addition levels on wheat straw MDF panel properties. The nominal panel density was 736 kg/m³ and the nominal MDF thickness was 12.5 mm. 10% UF resin and 1% slack wax were added, unless specified otherwise. Oil content is calculated on the basis of oven dry fibre weight.

TABLE 7
Effect of cedar oil loading level on MDF panel properties

| | MOE, | MOR, | IB, | TS, | WA, |
|---|---|---|---|---|---|
| Formulations | MPa | MPa | MPa | mm | % |
| Straw + resin + wax | 3249 | 25.9 | 0.869 | 1.9 | 46.4 |
| Straw + resin + wax + | 3480 | 28.6 | 1.030 | 2.6 | 69.8 |
| 0.25% cedar oil | | | | | |
| Straw + resin + wax + | 3303 | 27.2 | 1.145 | 1.9 | 48.7 |
| 0.50% cedar oil | | | | | |
| Straw + resin + wax + | 3421 | 28.6 | 1.157 | 2.2 | 55.8 |
| 0.75% cedar oil | | | | | |
| Straw + resin + wax + | 3278 | 26.6 | 1.228 | 1.3 | 30.0 |
| 1.00% cedar oil | | | | | |

### Example 6

Table 8 shows the relationship of different oil additives to wood based MDF panel properties.

The nominal wood MDF panel density was set at 736 kg/m³ and the nominal panel thickness was 12.5 mm. 10% UF resin and 1% slack wax were applied, unless noted otherwise. Oil content is measured on the oven dry wood fibre weight basis.

TABLE 8
Effect of oil types on wood-based MDF panel properties

| | MOE, | MOR, | IB, | TS, | WA, |
|---|---|---|---|---|---|
| Formulations | MPa | MPa | MPa | mm | % |
| Wood + resin + wax | 2167 | 21.3 | 1.161 | 1.0 | 17.9 |
| Wood + resin + wax + | 2162 | 21.1 | 1.471 | 0.9 | 17.1 |
| linseed oil | | | | | |
| Wood + resin + wax + | 2172 | 21.3 | 1.622 | 1.0 | 17.7 |
| corn oil | | | | | |

Examples 3-6 demonstrate that exemplary oils lead to increased acid-based characteristics and thus improved internal bond (IB) and dimensional stability of wheat straw and wood MDF.

What is claimed is:

1. A method of preparing a lignocellulosic fibre panel comprising the step of mixing the fibres with a resin, a wax and oil prior to mat forming and panel pressing.

2. The method of claim 1 wherein the panel is an MDF panel.

3. The method of claim 1 wherein the fibre is wood fibre.

4. The method of claim 1 wherein the fibre is agrifibre.

5. The method of claim 4 wherein the fibre is cereal straw fibre.

6. The method of claim 5 wherein the cereal straw fibre is wheat straw.

7. The method of claim 1 wherein the resin is a formaldehyde-based resin.

8. The method of claim 7 wherein the formaldehyde-based resin comprises urea-formaldehyde (UF), or melamine urea-formaldehyde (MUF).

9. The method of claim 1 wherein the wax is either slack wax or emulsified wax.

10. The method of claim 1 wherein oil is selected from different groups including, but not being limited to, vegetable oils, tree oils and any kinds of oils and oil mixtures which consist of fatty acids with 12 to 24 carbon atoms.

11. The method of claim 10 wherein after mixing lignocellulosic fibres with resin, wax and oil, the formulated fibre samples provide the dispersion force of resinated fibre samples in the range of 5.00 and 35.00 mJ/m² and the acid-base characteristic in the range of 0.55 and 3.50. The dispersive forces and acid-base characteristic are characterized by Inverse Gas Chromatography (IGC), as mentioned above.
